(19) United States
(12) Patent Application Publication
(10) Pub. No.: US 2010/0270884 A1
(43) Pub. Date: Oct. 28, 2010

(54) Zero phase

(76) Inventor: Robert Clayton Gehring, JR., Coconut Creek, FL (US)

Correspondence Address: Robert C. Gehring Jr., P. O. Box 276102, Boca Raton, FL, 33427-6102, US

(21) Appl. No.: 12/386,729

(22) Filed: Apr. 22, 2009

(51) Int. Cl. H02K 16/02

(52) U.S. Cl. 310/114

(57) ABSTRACT

One embodiment of a more efficient induction motor is using both sides of the electric magnetic coils (16) pushing off of the induction rings (14), (18) on both sides. This is achieved by using planetary gears (12).

### CROSS-REFERENCE TO RELATED APPLICATIONS

This application claims improvement on the electric induction motor.

### FEDERALLY SPONSORED RESEARCH

Not Applicable

### SEQUENCE LISTING OR PROGRAM

Not Applicable

### BACKGROUND OF THE INVENTION

1. Field

This invention generally relates to electric motors, specifically to electric induction motors.

2. Prior Art

Previously electric induction motors have only used one side of the magnetic field. Such as ceiling fans, remote controlled cars, and many other uses. The Zero Phase electric induction motor substantially increase efficiency with increased torque power.

### SUMMARY

In accordance with one embodiment, an induction motor using both sides of the magnetic field will increase efficiency as well as use full power.

### DRAWINGS—FIGURES

FIG. 1 is an exploded side view of the Zero Phase induction motor.

FIG. 2 is an end cross-section view of the Zero Phase induction motor.

FIG. 3 is an exploded side view of various combinations of the Zero Phase induction motor.

FIG. 4 is an end cross-section view of various combinations of the Zero Phase induction motor.

FIG. 5 is an end view of a planetary gear.

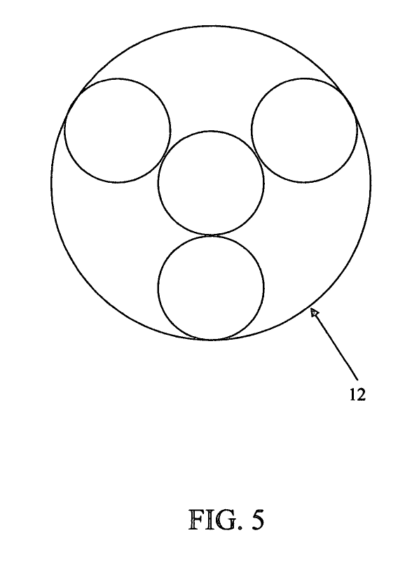

FIG. 6 is an end view of an expanded planetary gear.

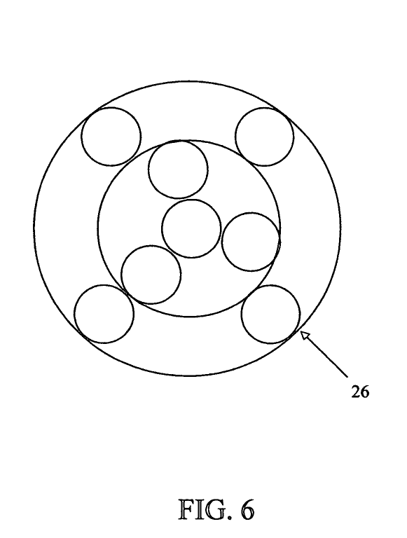

### DRAWING—REFERENCE NUMERALS

10 outer housing

12 planetary gear

14 outer induction ring

16 electro magnetic coils

18 inner induction ring

20 output shaft

22 electric input wire

24 double-sided induction ring

26 expanded planetary gear

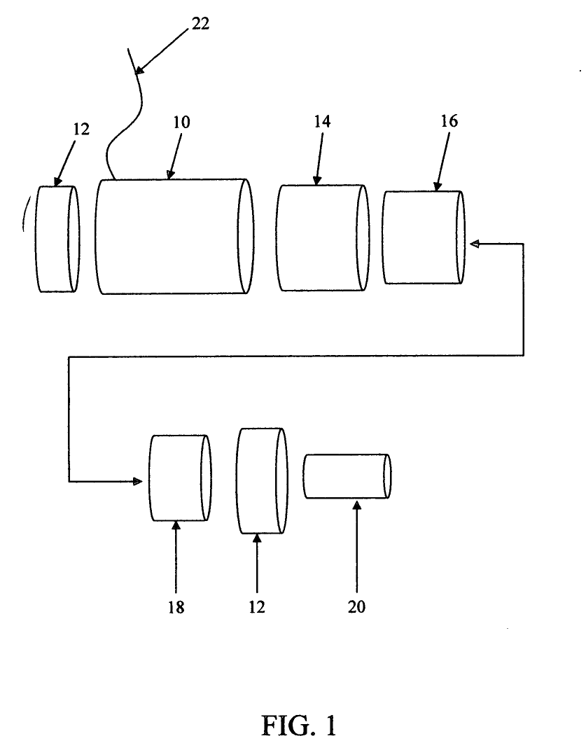

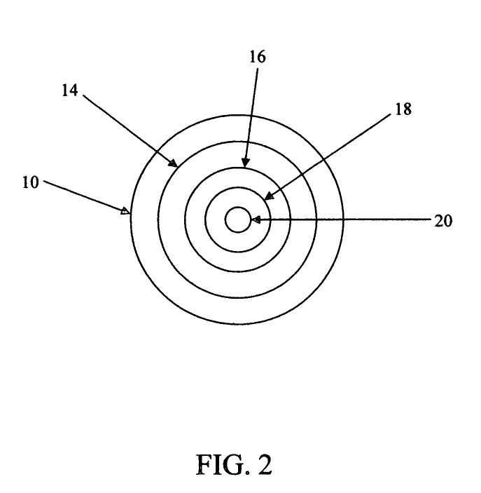

### Detailed Description—First Embodiment—FIG. 1 AND FIG. 2

One embodiment of the ZERO PHASE is illustrated in FIG. 1 (exploded side view) and FIG. 2 (end cross-section view) is a cut away section to show the inside of the ZERO PHASE motor. The electro magnetic coils 16 are centered between the outer induction ring 14 and the inner induction ring 18 at very close tolerance. The outer induction ring 14, electro magnetic coils 16, and inner induction ring are attached to planetary gears 12 at both ends. The planetary gears 12 in turn are held by the outer housing 10. The outer housing 10 is used to incase the motor as well as mounting the motor for use. The electric input wire 22 is used to supply the electric magnetic coils 16 with electricity.

### Operation—First Embodiment—FIG. 1 AND FIG. 2

The motor uses both sides of the electro magnetic coils 16 pushing the inner induction ring 18 and outer induction ring 14 simultaneously in opposite rotation. This is achieved by planetary gears 12 at either end of the induction rings 14,18 and the electro magnetic coils 16. Planetary gears 12 in turn connected to outer housing 10 for stability and support. The electric input wire 22 supplies the electro magnetic coils 16 with electricity.

### Description—Alternative Embodiments

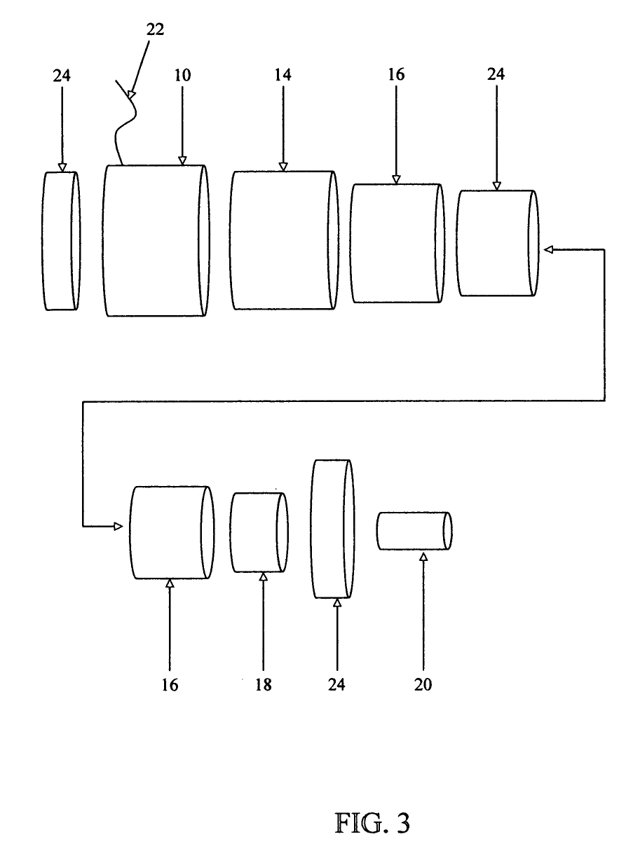

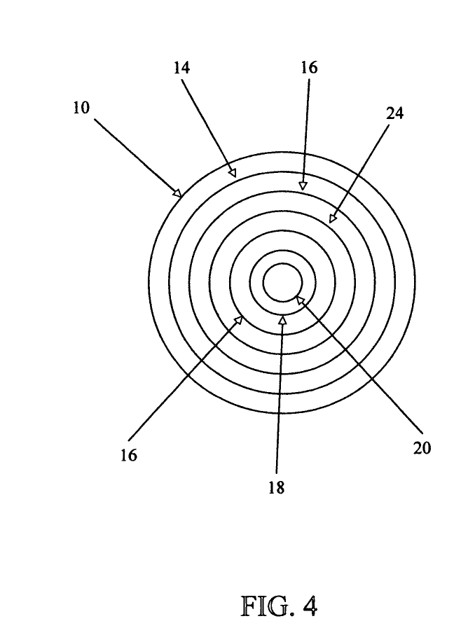

There are various possibilities with regard to the relative disposition of this design as illustrated in FIG. 3 and FIG. 4. Within this design the double-sided induction ring 24 and the electro magnetic coils 16 can be compounded multiple times.

### Operation—Alternative Embodiment

With the various possibilities in FIG. 3 and FIG. 4. By compounding the electro magnetic coils 16 and the double-sided induction rings 24 the efficiency and torque can be continuously increased. This can be accomplished by using expanded planetary gears 26.

### CONCLUSION, RAMIFICATIONS, AND SCOPE

Accordingly the reader will see that, to the one embodiment of the invention, I have provided a simple and more efficient improvement on the electric induction motor. Increased efficiency will save electric as well as increased power. As this is the potential way of future induction motors, this idea on redesigning the electric induction motor should not be taken lightly.

While the above description contains many specificities, these should not be construed as limitations on the scope of any embodiment, but as exemplifications of the presently preferred embodiment thereof. Many other ramification and variations are possible within the teachings of the various embodiments. For example compounding the induction rings and the electro magnetic coils.

Thus the scope of the embodiments should be determined by the appended claims and their legal equivalents, and not by the examples given

I claim:

1. Redesigning the electric induction motor using both sides of the magnetic fielded, this can be accomplished by the use of planetary gears.

2. The design of claim 1 wherein can be done in ac induction.

3. The design of claim 1 wherein can be done in dc induction, although there is nothing in the uspto, this inventor believes that dc induction is possible.

4. The design of claim 1 wherein can be done in dc induction permanent magnet.
